(19) United States
(12) Patent Application Publication
(10) Pub. No.: US 2018/0088829 A1
(43) Pub. Date: Mar. 29, 2018

(54) AREA EFFICIENT ARCHITECTURE FOR MULTI WAY READ ON HIGHLY ASSOCIATIVE CONTENT ADDRESSABLE MEMORY (CAM) ARRAYS

(71) Applicant: QUALCOMM Incorporated, San Diego, CA (US)

(72) Inventors: Harish SHANKAR, Raleigh, NC (US); Manish GARG, Cary, NC (US)

(21) Appl. No.: 15/710,108

(22) Filed: Sep. 20, 2017

Related U.S. Application Data
(60) Provisional application No. 62/401,614, filed on Sep. 29, 2016.

(51) Int. Cl. G06F 3/06

(52) U.S. Cl. CPC G06F 3/0611; G06F 3/0673; G06F 3/0659; G06F 3/0644

(57) ABSTRACT

Aspects disclosed herein relate to techniques and an efficient architecture for enabling multi-way reads on highly associative content addressable memory (CAM) arrays. For example, a method for performing a tag search of a tag array can include reading a first subset of stored tag bits from multiple entries of the tag array, and comparing a second subset of stored tag bits from a one or more entries of the tag array against a search-tag to produce one or more possible way hit signals.

### CLAIM OF PRIORITY UNDER 35 U.S.C. § 119

The present Application for Patent claims benefit of U.S. Provisional Patent Application Ser. No. 62/401,614, filed Sep. 29, 2016, assigned to the assignee hereof and hereby expressly incorporated by reference herein.

### BACKGROUND

### Field of the Disclosure

Aspects disclosed herein relate to the field of memory architecture. More specifically, aspects disclosed herein relate to content addressable memories (CAMs).

### Description of Related Art

Content Addressable Memory (CAM) is a type of memory that enables high-speed parallel searching of the memory for a desired data word. As such, CAMs may be used in search-intensive applications.

In high performance CPU architectures, the cache hit rate is a significant contributor to the overall achievable instructions per cycle (IPC) of the architecture. Server CPU architectures typically have larger cache sizes and a greater associativity than other architectures. A cache typically consists of a tag array which stores the tag to be compared against and a data array that stores the data corresponding to the tag. In most high bus width applications (e.g., 64 bit or higher), the higher order tag bits rarely change and hence these bits are compressed before being stored tag array. During a tag search, these compressed bits from all ways may be read out from the tag array to be compared against an external lookup table.

Such compression typically adversely impacts power, performance, or area (PPA) of the tag array, however, and causes timing penalty as the compressed bits may need to be looked up before a tag search.

Therefore, techniques and architectures for improving performance of reading CAM structures may be provided.

### SUMMARY

Aspects disclosed herein provide techniques and an efficient architecture for enabling multi-way reads on highly associative CAM arrays.

In one aspect, a method for performing a tag search of a tag array is provided. The method generally includes reading a first subset of stored tag bits from multiple entries of the tag array and comparing a second subset of stored tag bits from a one or more entries of the tag array against a search-tag to produce one or more possible way hit signals.

In one aspect, a method for performing a tag search of a tag array is provided. The method generally includes reading a first subset of stored tag bits from at least one entry of the tag array and reading a second subset of stored bits from the at least one entry if a condition is met.

In one aspect, a content addressable memory (CAM) structure is provided. The CAM structure generally includes a tag array, multi-way read logic for reading a first subset of stored tag bits from multiple entries of the tag array, and comparison logic for comparing a second subset of stored tag bits from a one or more entries of the tag array against a search-tag to produce one or more possible way hit signals.

In one aspect, a content addressable memory (CAM) structure is provided. The CAM structure generally includes a tag array, read logic for reading a first subset of stored tag bits from at least one entry of the tag array, and conditional read logic for reading a second subset of stored bits from the at least one entry if a condition is met.

### BRIEF DESCRIPTION OF THE DRAWINGS

So that the manner in which the above recited aspects are attained and can be understood in detail, a more particular description of aspects of the disclosure, briefly summarized above, may be had by reference to the appended drawings.

It is to be noted, however, that the appended drawings illustrate only aspects of this disclosure and are therefore not to be considered limiting of its scope, for the disclosure may admit to other aspects.

FIG. 1 is a functional block diagram of an exemplary computing device configured to operate according to aspects of the present disclosure.

FIG. 2 is a flow chart illustrating example operations for reading from multiple ways, according to aspects of the present disclosure.

FIG. 3 illustrates an example static read port according to aspects of the present disclosure.

FIG. 4 illustrates example logic for a conditional read of tag bits according to aspects of the present disclosure.

FIG. 5 illustrates an example tag bank layout according to aspects of the present disclosure.

FIG. 6 illustrates an exampleis a functional block diagram of an exemplary processor configured to execute instructions of an instruction set prepared by a process according to aspects of the present disclosure.

FIG. 7 is a flow chart illustrating example operations for performing a tag search of a tag array, according to aspects of the present disclosure.

### DETAILED DESCRIPTION

Aspects disclosed herein provide techniques for reading from multiple ways from a tag array.

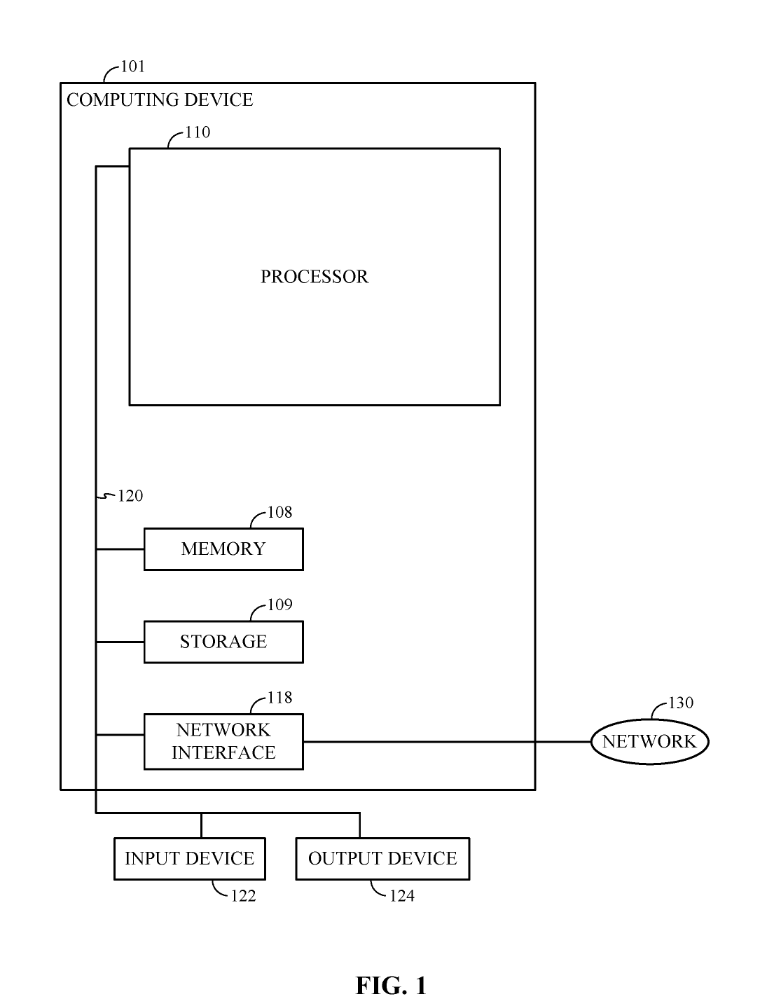

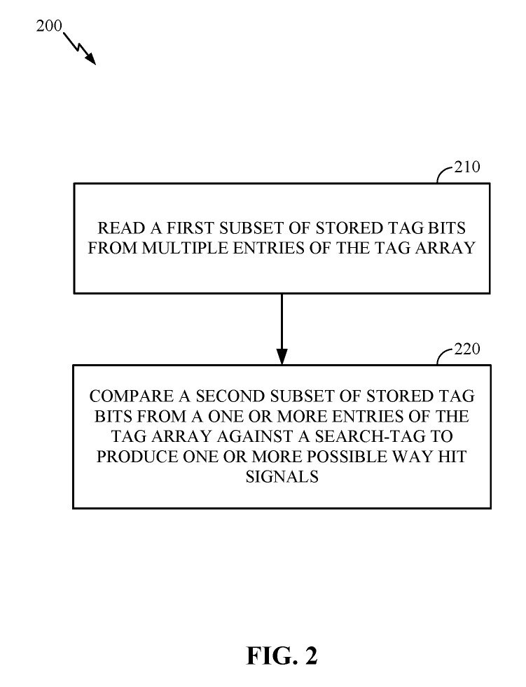

FIG. 1 is a block diagram illustrating a computing device 101 that may include a memory structure configured to operate according to aspects of the present disclosure. For example, the computing device may include a memory 108 with a cache having a tag array searchable by performing operations 200, shown in FIG. 2

The computing device 101 may also be connected to other computing devices via a network 130. In general, the network 130 may be a telecommunications network and/or a wide area network (WAN). In a particular aspect, the network 130 is the Internet. Generally, the computing device 101 may be any type of computing device configured to synthesize computer machine instructions, including, without limitation, a desktop computer, a server, a laptop computer, and a tablet computer.

The computing device 101 generally includes a processor 110 connected via a bus 120 to a memory 108, a network interface device 118, a storage 109, an input device 122, and an output device 124. The computing device 101 generally operates according to an operating system (not shown). Any operating system supporting the functions disclosed herein may be used. The processor 110 is included to be representative of a single processor, multiple processors, a single processor having multiple processing cores, and the like. The network interface device 118 may be any type of network communications device allowing the computing device 101 to communicate with other computing devices via the network 130.

The storage 109 may be a persistent storage device. Although the storage 109 is shown as a single unit, the storage 109 may be a combination of fixed and/or removable storage devices, such as fixed disc drives, solid state drives, SAN storage, NAS storage, removable memory cards or optical storage. The memory 108 and the storage 109 may be part of one virtual address space spanning multiple primary and secondary storage devices.

The input device 122 may be any device operable to enable a user to provide input to the computing device 101. For example, the input device 122 may be a keyboard and/or a mouse. The output device 124 may be any device operable to provide output to a user of the computing device 101. For example, the output device 124 may be any conventional display screen and/or set of speakers. Although shown separately from the input device 122, the output device 124 and input device 122 may be combined. For example, a display screen with an integrated touch-screen may be a combined input device 122 and output device 124.

As noted above, the memory 108 may include a cache structure. In some cases, the cache may include a tag array which stores the tag to be compared against and a data array that stores the data corresponding to the tag. In some applications, reading key bits from all WAYs, may present a challenge in CAM based tag arrays, because the bitlines are shared across tag entries from different ways. Having separate bitlines and associated peripheral circuitry would significantly degrade the array efficiency of the tag array.

Aspects of the present disclosure provide techniques and a corresponding architecture that allows for “multi-way” reading of a first set of tag bits from multiple rows, while reading a second set of tag bits from one or more single rows. In some cases, the first set of tag bits may be compressed bits (e.g., higher order address bits that are not likely to change often). In some cases, the reading of the first subset of stored tag bits is accomplished via a static read operation.

FIG. 2 is a flow chart illustrating a method that includes operations 200 for reading a tag array that may be performed in a cache memory, for example, by logic within memory 108 shown in FIG. 1, according to aspects of the present disclosure.

At block 210, the method begins by reading a first subset of stored tag bits from multiple entries of the tag array. At block 220, the method continues by performing a comparison of a second subset of stored tag bits from one or more entries of the tag array against a search-tag to produce one or more possible way hit signals. The hit signals may be considered possible because, even though these bits match, further resolution may be needed, for example, after decoding compressed bits. In accordance with one or more cases, a search-tag may be described as a tag portion of an address being accessed from a memory.

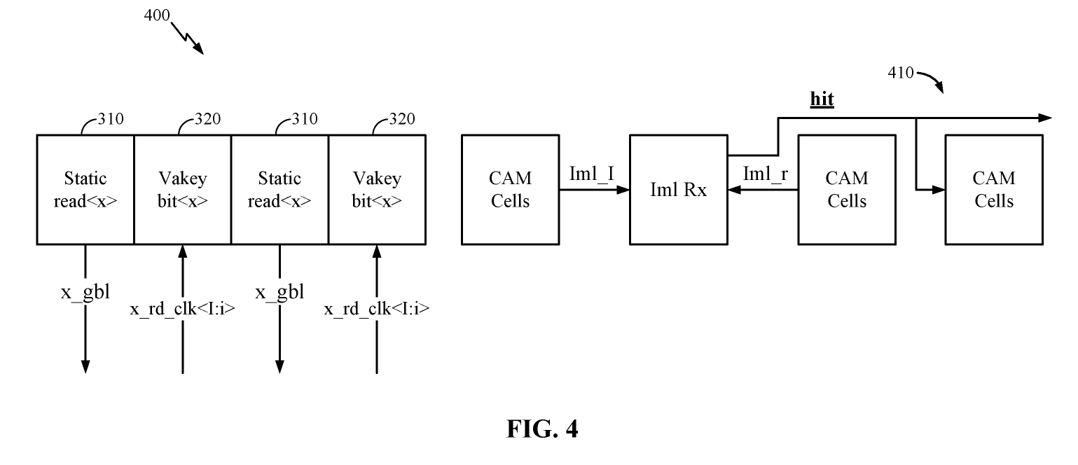

In some cases, tag compare logic may be implemented using Content Addressable Memory (CAM) bitcells. Further, the match lines of the CAM bitcells may be combined in a match line receiver circuit, as shown in FIG. 4, which generates a ‘hit’ signal which drives a global read word line, ‘grwl’, of the data array. In some cases, certain bits, such as permission and parity bits may be required only for the way that ‘hits.’ Hence, the output of the match line receiver may act as a read word line (‘rwl’) of these bits.

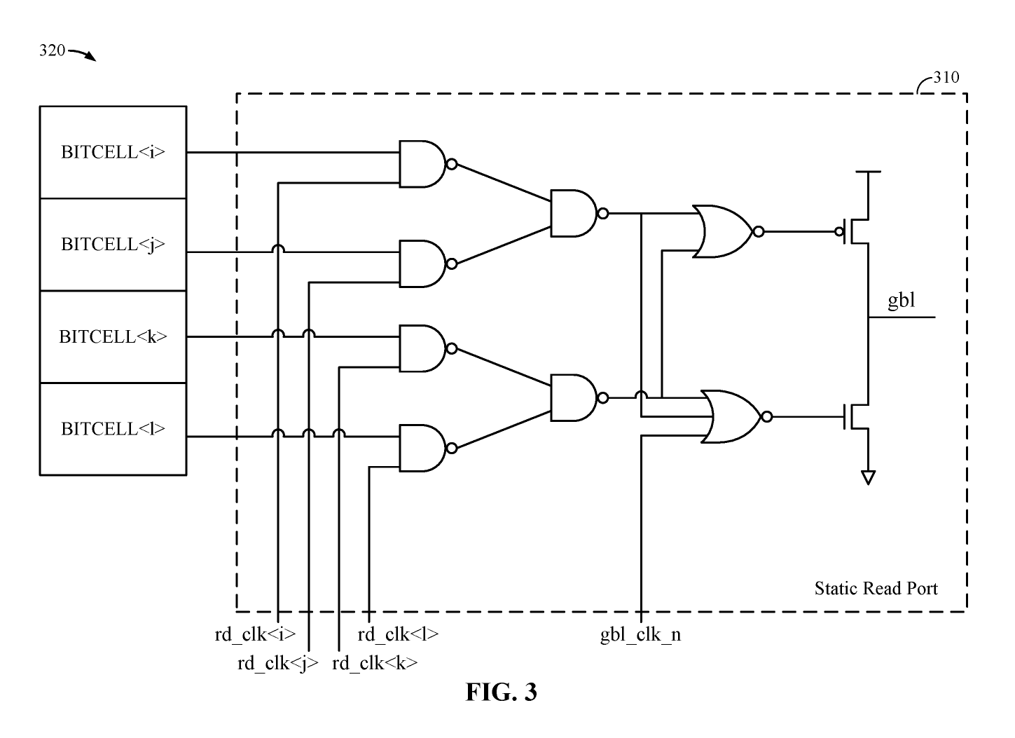

In some cases, compressed higher order bits (which may be referred to as virtual address key or VAKEY) may be read through a static read port stacked beside the bitcell in the tag row, as illustrated in FIG. 3.

FIG. 3 illustrates an example of such a static read port 310 that effectively multiplexes (muxes) the data bits from 4 adjacent bitcells 320 to a single global bitline (gbl) driver in the tag row. Integrating this ‘gbl’ driver into the tag row may help reduce the inclusion of duplicated peripheral circuits to read all ways from the array, which improves the array efficiency of the tag array. Further, because a static read option is used, the dynamic energy associated with the read of the VAKEY bits may be significantly reduced using this technique.

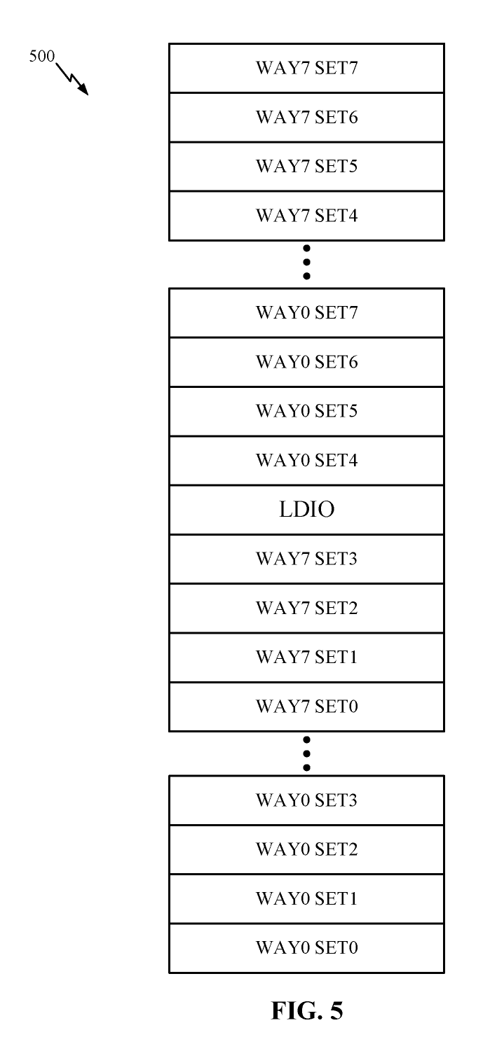

FIG. 4 illustrates an example of an overall tag row floorplan 400 in accordance with certain aspects. In some cases, to mux the 4 bitcells 320 from adjacent rows into a single gbl driver via a static read port 310, it may be an objective that the 4 bitcells belong to the same WAY of different sets. FIG. 5 illustrates an example bank structure 500 with such a floorplan to achieve this objective. In the example bank structure 500, different sets for the same way are arranged together. For example, starting at the bottom, way 0 and sets 0-3 are arranged together, while moving to the top way 7 and sets 4-7 are arranged together.

Referring again to FIG. 4, in some cases, other types of bits from certain cells 410 may be read out when certain conditions are met. For example, permission and parity bits may be read out during a tag search for a corresponding row that hits. Hence, the output of the match line receiver may act as a read word line (‘rwl’) for these bits. This may help conserve power by accessing such bits only when needed.

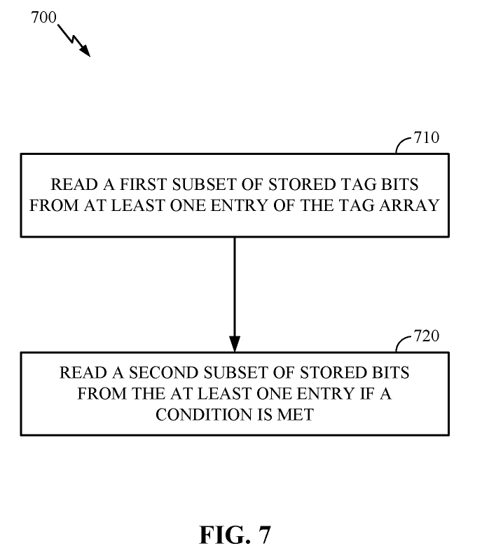

FIG. 7 is a flow chart illustrating example operations 700 for performing a tag search of a tag array, according to aspects of the present disclosure. In one or more cases, the operations 700 for performing a tag search of a tag array as shown in FIG. 7 may include, as shown at block 710, reading a first subset of stored tag bits from at least one entry of the tag array. The operations 700 may also include, at block 720, reading a second subset of stored bits from the at least one entry only if a condition is met.

In some cases, the condition may include a tag hit for the at least one entry. Further, the second subset of stored bits may include at least one of permission bits or parity bits. A tag hit may be defined as the occurrence of when the value stored in the second subset of stored tag bits matches with an incoming address.

The architecture presented herein may result in significant area savings (e.g., of more than 10%) when compared with alternative techniques such as not compressing the higher order bits or using duplicated peripheral circuits in place of a static read port proposed herein. Such an architecture may be implemented in a memory structure which, in some cases, may be incorporated in a processor.

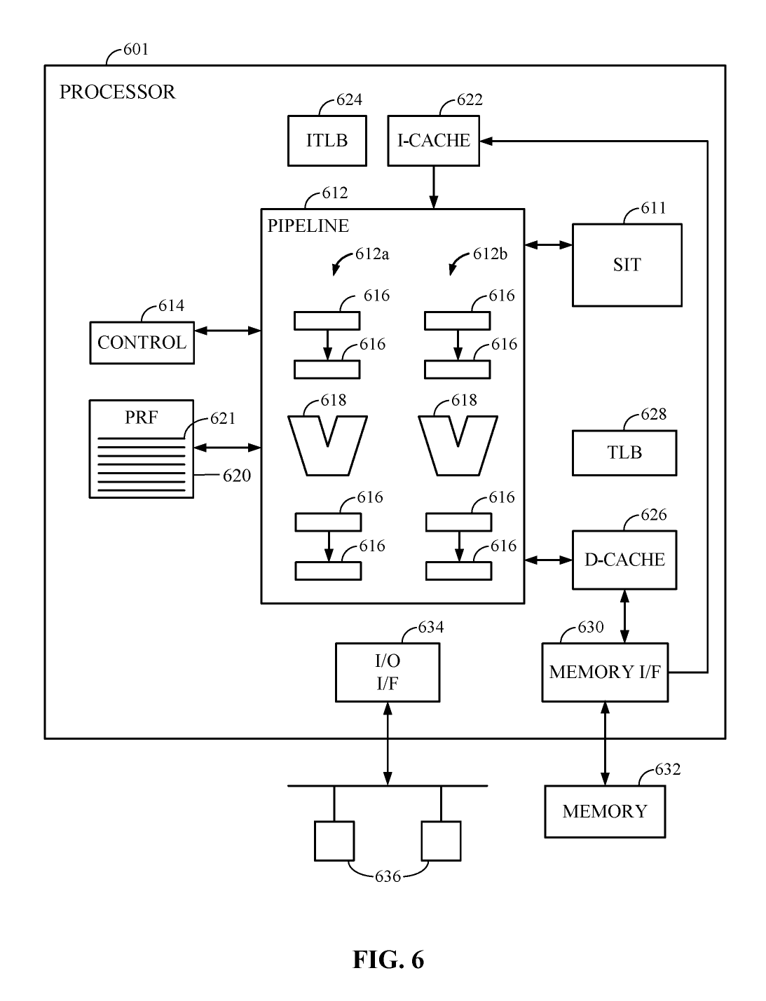

For example, FIG. 6 is a functional block diagram of such an example processor (e.g., a CPU) 601 which may be configured with cache structures that operate according to aspects of the present disclosure. The processor 601 may be an example of the processor 110 shown in FIG. 1. Generally, the processor 601 may be used in any type of computing device including, without limitation, a server, a desktop computer, a laptop computer, a tablet computer, and a smart phone. Generally, the processor 601 may include numerous variations, and the processor 601 shown in FIG. 6 is for illustrative purposes and should not be considered limiting of the disclosure. For example, the processor 601 may be a graphics processing unit (GPU). In one aspect, the processor 601 is disposed on an integrated circuit including an instruction execution pipeline 612 and a storage instruction table (SIT) 611.

Generally, the processor 601 executes instructions in an instruction execution pipeline 612 according to control logic 614. The control logic 614 may be an embodiment of an instruction set architecture comprising an instruction set prepared by the process described in FIG. 2, according to aspects of the present disclosure. The pipeline 612 may be a superscalar design, with multiple parallel pipelines, including, without limitation, parallel pipelines 612a and 612b. The pipelines 612a, 612b include various non-architected registers (or latches) 616, organized in pipe stages, and one or more arithmetic logic units (ALU) 618. A physical register file 620 includes a plurality of architected registers 621.

The pipelines 612a, 612b may fetch instructions from an instruction cache (I-Cache) 622, while an instruction-side translation lookaside buffer (ITLB) 624 may manage memory addressing and permissions. Data may be accessed from a data cache (D-cache) 626, while a main translation lookaside buffer (TLB) 628 may manage memory addressing and permissions. In some aspects, the ITLB 624 may be a copy of a part of the TLB 628. In other aspects, the ITLB 624 and the TLB 628 may be integrated. Similarly, in some aspects, the I-cache 622 and D-cache 626 may be integrated, or unified. Misses in the I-cache 622 and/or the D-cache 626 may cause an access to higher level caches (such as L2 or L3 cache) or main (off-chip) memory 632, which is under the control of a memory interface 630. The processor 601 may include an input/output interface (I/O IF) 634 that may control access to various peripheral devices 636.

A number of aspects have been described. However, various modifications to these aspects are possible, and the principles presented herein may be applied to other aspects as well. The various tasks of such methods may be implemented as sets of instructions executable by one or more arrays of logic elements, such as microprocessors, embedded controllers, or IP cores.

The foregoing disclosed devices and functionalities may be designed and configured into computer files (e.g. RTL, GDSII, GERBER, etc.) stored on computer readable media. Some or all such files may be provided to fabrication handlers who fabricate devices based on such files. Resulting products include semiconductor wafers that are then cut into semiconductor die and packaged into a semiconductor chip. Some or all such files may be provided to fabrication handlers who configure fabrication equipment using the design data to fabricate the devices described herein. Resulting products formed from the computer files include semiconductor wafers that are then cut into semiconductor die (e.g., the processor 101) and packaged, and may be further integrated into products including, but not limited to, mobile phones, smart phones, laptops, netbooks, tablets, ultrabooks, desktop computers, digital video recorders, set-top boxes, servers, and any other devices where integrated circuits are used.

In one aspect, the computer files form a design structure including the circuits described above and shown in the Figures in the form of physical design layouts, schematics, a hardware-description language (e.g., Verilog, VHDL, etc.). For example, design structure may be a text file or a graphical representation of a circuit as described above and shown in the Figures. Design process preferably synthesizes (or translates) the circuits described below into a netlist, where the netlist is, for example, a list of wires, transistors, logic gates, control circuits, I/O, models, etc. that describes the connections to other elements and circuits in an integrated circuit design and recorded on at least one of machine readable medium. For example, the medium may be a storage medium such as a CD, a compact flash, other flash memory, or a hard-disk drive. In another embodiment, the hardware, circuitry, and method described herein may be configured into computer files that simulate the function of the circuits described above and shown in the Figures when executed by a processor. These computer files may be used in circuitry simulation tools, schematic editors, or other software applications.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

The previous description of the disclosed aspects is provided to enable a person skilled in the art to make or use the disclosed aspects. Various modifications to these aspects will be readily apparent to those skilled in the art, and the principles defined herein may be applied to other aspects without departing from the scope of the disclosure. Thus, the present disclosure is not intended to be limited to the aspects shown herein but is to be accorded the widest scope possible consistent with the principles and novel features as defined by the following claims.

What is claimed is:

1. A method for performing a tag search of a tag array, comprising:
reading a first subset of stored tag bits from multiple entries of the tag array; and
comparing a second subset of stored tag bits from one or more entries of the tag array against a search-tag to produce one or more possible way hit signals.

2. The method of claim 1, wherein the comparing of the second subset of stored tag bits is performed via a content addressable memory (CAM) port.

3. The method of claim 1, wherein the first subset of stored tag bits comprise bits that are compressed before being stored in the tag array.

4. The method of claim 1, wherein the first subset of stored tag bits are read from multiple entries corresponding to multiple physical rows in a same bank of the tag array.

5. The method of claim 1, wherein the first subset of stored tag bits comprise higher order address bits that are compressed before being stored in the tag array.

6. The method of claim 1, wherein:
the reading of the first subset of stored tag bits is accomplished via a static read operation.

7. The method of claim 1, further comprising:
reading a third subset of stored bits from a single physical row if a condition is met.

8. The method of claim 7, wherein the condition comprises a tag hit for the single physical row.

9. The method of claim 8, wherein the third subset of stored bits comprise at least one of permission bits or parity bits.

10. A method for performing a tag search of a tag array, comprising:
reading a first subset of stored tag bits from at least one entry of the tag array; and
reading a second subset of stored bits from the at least one entry if a condition is met.

11. The method of claim 10, wherein the condition comprises a tag hit for the at least one entry.

12. The method of claim 11, wherein the second subset of stored bits comprise at least one of permission bits or parity bits.

13. A content addressable memory (CAM) structure, comprising:
a tag array;
multi-way read logic for reading a first subset of stored tag bits from multiple entries of the tag array; and
comparison logic for comparing a second subset of stored tag bits from one or more entries of the tag array against a search-tag to produce one or more possible way hit signals.

14. The CAM structure of claim 13, wherein:
the comparison logic comprises a CAM port.

15. The CAM structure of claim 13, wherein the first subset of stored tag bits comprise bits that are compressed before being stored in the tag array.

16. The CAM structure of claim 13, wherein the multi-way read logic reads the first subset of stored tag bits from multiple entries corresponding to multiple physical rows in a same bank of the tag array.

17. The CAM structure of claim 13, wherein the first subset of stored tag bits comprise higher order address bits that are compressed before being stored in the tag array.

18. The CAM structure of claim 13, wherein:
the multi-way read logic is comprised of a static read port with adjacent bit cells from different physical rows.

19. The CAM structure of claim 13, wherein:
the tag array is arranged in banks; and
each bank is arranged as physical rows, each physical row in a bank corresponding to a common way and a different set.

20. The CAM structure of claim 13, further comprising:
conditional read logic for reading a third subset of stored bits from a single physical row if a condition is met.

21. The CAM structure of claim 20, wherein the condition comprises a tag hit for the single physical row.

22. The CAM structure of claim 21, wherein the third subset of stored bits comprise at least one of permission bits or parity bits.

23. A content addressable memory (CAM) structure, comprising:
a tag array;
read logic for reading a first subset of stored tag bits from at least one entry of the tag array; and
conditional read logic for reading a second subset of stored bits from the at least one entry if a condition is met.

24. The CAM structure of claim 23, wherein the condition comprises a tag hit for a single physical row.

25. The CAM structure of claim 24, wherein the second subset of stored bits comprise at least one of permission bits or parity bits.
